(19) United States
(12) Patent Application Publication
(10) Pub. No.: US 2015/0337147 A1
(43) Pub. Date: Nov. 26, 2015

(54) REVERSIBLE POLYMERS IN 3-D PRINTING

(71) Applicant: XEROX CORPORATION, NORWALK, CT (US)

(72) Inventors: James Daniel Mayo, Mississauga (CA); Brynn Mary Dooley, Toronto (CA)

(73) Assignee: XEROX CORPORATION, NORWALK, CT (US)

(21) Appl. No.: 14/285,515

(22) Filed: May 22, 2014

(51) Int. Cl. C09D 11/102; B29C 67/00; C09D 11/30

(52) U.S. Cl. CPC C09D 11/102; C09D 11/30; B29C 67/0059; B29K 2079/08

(57) ABSTRACT

An ink jettable 3-D material composition includes a reversible polymer material, which can reversibly transition between a liquid state and a solid state by reversible cyclo-addition reactions, wherein upon cooling, the reversible polymer material transitions from a liquid state to a solid state by reversible cyclo-addition reactions within a time period of less than about 10 seconds.

### TECHNICAL FIELD

The present disclosure generally relates to the formation of three-dimensional objects and, in particular, to methods and compositions for use in three-dimensional printing of objects comprising reversible polymer materials.

### BACKGROUND

Three-dimensional (3-D) printing has received a great deal of attention in recent years. Several different methods exist, enabling the preparation of novelties, prototypes and working structures. One of the more common techniques is the fused deposition method (FDM). Many different materials, such as polymers, waxes, and even molten metals, have been proposed as the material of choice for this form of printing. In FDM, an object is printed by jetting, extrusion, or other means in a layer-by-layer fashion on a substrate. As multiple layers are added successively, the 3-D object is built vertically on the substrate. If the material is to be jetted out of a typical ink jet nozzle, the requirements for the material used for printing are similar to those for a solid ink. The material must have low melt viscosity to be jetted from a print head at a reasonable temperature (<140° C.), but form a robust solid when cooled to room temperature.

UV curable materials, such as UV curable resins, are often used in this capacity, as they are easily jetted at relatively low temperatures, and can form extremely robust solids after photo-curing. This manufacturing process is capable of forming 3-D objects having complicated shapes in a shorter time than the conventional manufacturing processes such as machining and casting. However, the use of UV light during manufacturing adds cost, complexity and safety issues typically associated with a UV curable resin. Without the UV-hardening step, conventional polymer materials cannot at once be easily jetted and form hard solids when cooled. Jettable materials are generally too soft when cooled, and hard materials are generally too viscous when heated for jetting.

Further, in 3-D printing, and in many cases, the 3-D object being printed can have features or appendages that require a temporary supporting network as the printed layers are formed. When 3-D printing is completed and the appendages of the printed object become self-supporting, this temporary supporting structure, or sacrificial material, can be eliminated. In conventional 3-D technologies, the removal of the sacrificial material can be accomplished with the use of mechanical energy using abrasives or forced air, or by other external stimuli. Ideally, one would like to avoid physically harsh methods, such that the integrity of the permanent structure is not compromised. External heating can be used to melt away the sacrificial material, but this could place several constraints on the 3-D printed object. The materials of the 3-D object and the sacrificial structure would need to have significantly different melting points, so that the temporary solid structure can be selectively removed without melting the permanent solid structure. Furthermore, the sacrificial material would need to be sufficiently robust in its solid state to support the object being printed, while having a low enough melt viscosity to allow it to be jetted from a piezoelectric printhead, and to flow when heat is applied to the printed structure.

A group of printable ink materials are called reversible Diels-Alder based polymer materials. Reversible Diels-Alder based polymers are generally known and have been investigated for use in solid ink printing, as exemplified for example by U.S. Pat. Nos. 5,844,020, 5,952,402, and 6,042,227, the disclosures of which are incorporated herein in their entireties. However, the Diels-Alder based polymers previously investigated suffer from long solidification times after being deposited on a substrate. For example, many of the prior Diels-Alder based polymers have solidification times on the order of several hours or days, making them unsuitable for use in most solid ink printing applications. Long solidification times are unsuitable because, while the printed material remains in a liquid or semi-liquid state, the image can become distorted, image quality can degrade, and the printed images cannot be stacked on top of each other resulting in either large space needs or low throughput.

Similarly, printing of 3-D objects requires materials that will harden relatively quickly upon cooling, such that they retain their shape and position. Therefore, there is a need for improved 3-D object forming techniques using polymers as the principal material for jetting in 3-D printers. There is also a need for improved materials having short solidification times to permit their use in 3-D printing technology.

### SUMMARY

The following detailed description is of the best currently contemplated mode of carrying out exemplary embodiments herein. The description is not to be taken in a limiting sense, but is made merely for the purpose of illustrating the general principles of the exemplary embodiments herein, since the scope of the disclosure is best defined by the appended claims.

Various inventive features are described below that may each be used independently of one another or in combination with other features.

Broadly, embodiments of the disclosure herein generally provide an ink composition for three-dimensional printing of objects including a reversible polymer material; and wherein the ink composition in a liquid state has a viscosity of from about 1 to about 100 cPs at a temperature of from about 75° C. to about 200° C.

In another embodiment, a method of forming a three-dimensional object includes depositing an ink composition in layers over a surface; cooling one of the layers of ink composition; wherein the ink composition includes a reversible polymer material; and wherein the reversible polymer material transitions from a liquid state to a solid state within a time period of up to about 60 seconds.

In yet another embodiment, a method of forming a three-dimensional object includes ink jetting an ink composition in layers over a surface; solidifying one of the layers of ink composition; wherein the ink composition includes a reversible polymer material; and wherein the ink composition, when solidified, has a hardness value of from about 0.25 GPa to about 0.60 GPa.

### BRIEF DESCRIPTION OF THE DRAWINGS

FIG. 1A and FIG. 1B show viscosity properties of reversible polymer materials according to embodiments herein.

FIG. 2A and FIG. 2B show rheological data of reversible polymer materials according to embodiments herein.

### DETAILED DESCRIPTION

The present disclosure provides ink compositions including one or more reversible polymers for forming three-dimensional (3-D) structures using a fused deposition method (FDM). Embodiments herein build or print the 3-D objects by depositing the polymer(s) in successive layers additively, ultimately leading to a 3-D structure. In embodiments, inks or solutions of the reversible polymer(s) are jetted onto a substrate to form or print a 3-D structure as the intended 3-D product and/or a sacrificial 3-D product, i.e., temporary support structure. Once the intended 3-D product is formed, sacrificial 3-D support products are removed from the intended 3-D product.

Whether used as the intended product structure or sacrificial product structure, the reversible polymer materials of the ink compositions herein may be formed from constituent materials based on Diels Alder chemistry, which can quickly and reversibly transition between a liquid state and a solid state by reversible cyclo-addition reactions. Such ink compositions exhibit jettable viscosities in the melt, while affording robust solids upon cooling. Because they can form robust solids at room temperature while having low viscosities at typical jetting temperatures, reversible polymers are suitable for embodiments herein. By nature of the collapse of the polymer into its individual monomeric segments upon heating, the melt viscosities of reversible polymers are much lower than what would be observed with conventional polymers. In embodiments herein, the low melt viscosities enable easy removal of the solid sacrificial material after printing of the intended product is completed or when the sacrificial product is no longer needed.

Various uses of reversible polymer materials are also described in commonly-assigned co-pending U.S. patent applications: Ser. No. 13/905,833, filed on May 30, 2013, entitled “Undercoat Composition for Ink Jet Printing”; Ser. No., filed on, entitled “Overcoat Composition for Ink Jet Printing”; Ser. No. 13/905,309, filed on May 30, 2013, entitled “Reversible Polymer Adhesive Composition”; Ser. No. 13/905,729, filed on May 30, 2013, entitled “Stabilized Reversible Polymer Composition”; and Ser. No. 13/905,314, filed on May 30, 2013, entitled “Reversible Polymer Composition,” the disclosures of which are hereby expressly incorporated in their entireties herein.

Reversible polymers can exist in different forms. The materials referred to in the present invention are comprised of two bis-functional molecules, in which the endgroups on each of the molecules can undergo a reversible reaction with one another, in the following fashion.

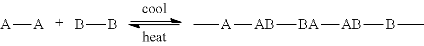

Alternatively, a single molecule can be designed having a different reactive endgroup on either end, as in A-B. In some instances, the endgroups can be chosen such that they couple to themselves, as is the case with dicyclopentadiene. In all of these cases, coupling of the bipodal molecules results in linear polymers having reactive endgroups. The concept is not restricted to bipodal molecules however, as it can also be effected using tripodal, tetrapodal and other multipodal systems, provided the endgroups of the monomers combine reversibly with one another or with themselves. These multipodal systems can result in highly cross-linked systems, which provide certain mechanical advantages. Still further, conventional polymers can be prepared so as to have pendant ligands capable of undergoing reversible reactions, thus enabling the existing chains to undergo reversible cross-linking reactions. Diels Alder chemistry is commonly used in this field, as it satisfies all the criteria for a reversible system: the reaction exhibits atom economy, as no small molecules are consumed or expelled during the reaction, no catalysts or additives are required for the reaction to proceed in either direction, and the reaction generates strong covalent bonds. The Diels Alder reaction is well known and occurs as a thermally reversible cycloaddition between a diene and dienophile, to yield a six-membered ring system. Cyclization requires that the diene be present in the cis configuration, and for this reason, cyclic dienes are often used. Ideally, the diene will contain electron donating groups (EDG), while the dienophile will contain electron withdrawing groups (EWG). To this end, furans and maleimides are very commonly used in Diels Alder chemistry, although this is not a specific restriction.

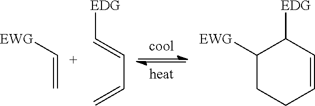

Furthermore, numerous other methodologies and chemistries may be used to generate reversible polymers, such as, but not limited to, hydrogen bonding, metal-ligand bonding, and transesterification.

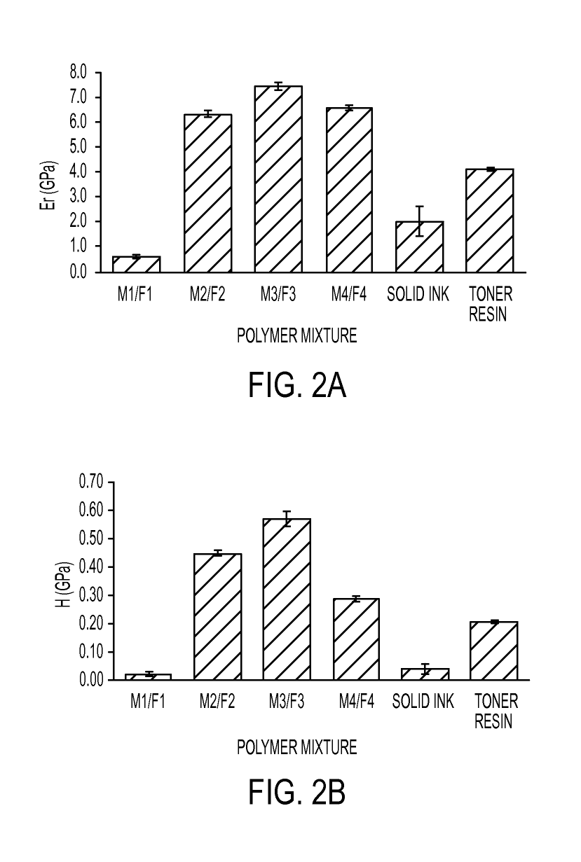

In the case of the linear systems just described, the spacer chemistry between the reactive end groups in the dimeric monomer units influences several of the physical properties of the reversible polymer materials herein—whether for an intended product structure or a sacrificial product structure. The viscosities of the reversible polymer molten liquids, as well as the rheology and adhesion properties of the resulting solid films, can be controlled by varying the spacer group chemistry. Furthermore, the time required for the phase transition from liquid to solid can also be influenced by the spacer chemistry, and this can be used to control the edge acuity of vertical piles of ink forming in 3-D printing herein. These variable properties can be leveraged to prepare a reversible polymer that can be used in embodiments herein. The hardness and modulus characteristics (shown in FIGS. 2A-2B) can be suitable for many 3-D object building applications.

In conventional ink jet printing, the ink solidification time must be minimized, but rapid solidification may have an adverse effect on layer-to-layer integrity by quickly forming an impervious and hardened deposition surface for the next material layer to adhere to. According to embodiments herein, slower solidification times can allow for improved layer-to-layer integrity, because a new material layer can contact a softer, more receptive or adhesive material layer jetted prior to the new layer. Herein, the ability to control solidification time after the material has been jetted allows for improved connectivity, uniformity and smoothness between layers of the 3-D printed object.

According to embodiments herein, the material forming the intended 3-D object may or may not be made of reversible polymer materials. Once formation of the printed figure is completed, removal of the sacrificial material can be accomplished easily by heating above the melting point of the reversible polymer in the sacrificial material. Unlike conventional polymers, which typically form very viscous liquids when heated, the reversible polymer(s) herein can transition into a low viscosity liquid, which can be readily drained away. Forced air can be used to expedite the process, if desired. Additionally, due to the reversible nature of the polymers herein, the intended 3-D objects or the sacrificial material pieces are recyclable, i.e., the material can be melted and reused.

### Composition

The ink composition of embodiments herein includes a reversible polymer material made of one or more reversible polymers. These materials are “curable” in that they can be deposited on a substrate in a low viscosity liquid state, making them suitable for deposition methods such as spraying, coating, ink jet printing, and the like. The materials can co-exist in a molten or liquid state as a low viscosity liquid. However, as the materials are cooled, cyclo-addition can take place, resulting in hard polymers with excellent film forming and adhesion characteristics. The reversible nature of the reaction also allows the composition to be repeatedly heated and cooled in printing apparatus to match printing demand.

In embodiments herein, the reversible polymer materials can have solidification times on the order of seconds. Due to the fast solidification times, the deposited polymer films retain their high quality, the deposited polymer films can be stacked on top of each other, and faster throughput can be achieved. Thus, in embodiments, the solidification time of the reversible polymer material can be less than about 10 seconds, or less than about 5 seconds, or less than about 3 seconds. For example, the solidification time for the reversible polymer material can be from about 0.01 second to about 0.05 second, or from about 0.1 second to about 0.5 second, or about 1 second, or about 5 seconds.

“Solidification” herein means that the reversible polymer material is hardened and emits an audible clicking sound when tapped with a spatula. For example, when materials are prepared as films not exceeding about 5 mm in thickness, the rate of cooling is fast and does not play a role in the solidification times of each of the materials. In these materials, the solidification time is the cooling time to ambient or room temperature. The degree of polymerization can be measured using ¹H NMR spectroscopy, although the degree of polymerization does not necessarily correlate with solidification times.

In embodiments, the use of a spacer molecule (e.g., linear alkyl C8 chain) can form completely opaque (white) reversible polymer films through which less than about 60% of visible light transmits. In other embodiments, the reversible polymer films are substantially transparent, such that greater than about 60% of visible light transmits through the films. Further, in various embodiments, the reversible polymer films are transparent such that greater than about 95% of visible light transmits through the films.

In embodiments, brittleness of the reversible polymer film may, for example, be determined by failure of a hardened film caused by a steel ball of known weight dropped on the film from a height of 25 cm. The weight of the steel balls used can be progressively increased—such as from 1, 2, 3, 5, 10, 15, 20, 25 and then 30 grams of weight—until failure is reached. Failure or brittleness may be defined as the appearance of multiple visible cracks radiating from the point of contact of the steel ball. In embodiments, brittleness can be from about 1 g to about 30 g, or from about 5 g to about 30 g, or from about 10 g to about 25 g.

In various embodiments, a hardness value for the reversible polymer materials may be of from about 0.25 GPa to about 0.60 GPa, or from about 0.30 GPa to about 0.45 GPa, or from about 0.45 GPa to about 0.55 GPa.

Nanoindentation can be used to determine hardness, where an indenter tip with well-known geometry is used to penetrate a sample made of reversible polymer film under load controlled conditions. The depth of penetration is used to calculate the exact area of indentation which, in turn, allows for calculation of the hardness (H) of the material, as the maximum load over the area of penetration. A plot of the load vs displacement of the tip during indentation can be recorded, and the stiffness and reduced modulus (Eᵣ) of the material can be calculated from the unloading curve.

“Reduced modulus value” herein means a measure of material stiffness under load, as measured by nanoindentation technique. According to embodiments, the reduced modulus value (Eᵣ) for the reversible polymer materials may be of from about 6.0 GPa to about 8.0 GPa, or from about 6.3 GPa to about 7.5 GPa, or from about 6.5 GPa to about 7.5 GPa.

Embodiments of the present disclosure utilize reversible polymer materials that are formed from one or more maleimides and/or furans, with varying linking chemistry. The maleimides and furans can be in any form, such as bismaleimides and bisfurans, trigonal maleimides and trigonal furans, and the like. The linking groups can vary in length and chemistry and can include, for example, linear or branched alkyl groups, cyclic alkyl groups, aryl groups, arylalkyl groups, alkylaryl groups, alkylenedioxy groups, and the like, all of which can be substituted or unsubstituted. Although not limited, it is believed that as the size of linking group increases, the solidification time increases. For example, as the number of carbon atoms in the linking group increases, or as the number of oxygen atoms (such as in alkyleneoxy groups) in the linking group increases, the solidification time also tends to increase. Of course, it still may be possible to use compounds with otherwise slower solidification times, for example, if they are used in combination with other materials having a faster solidification time.

For example, suitable bismaleimides and bisfurans are represented by the following chemical structures:

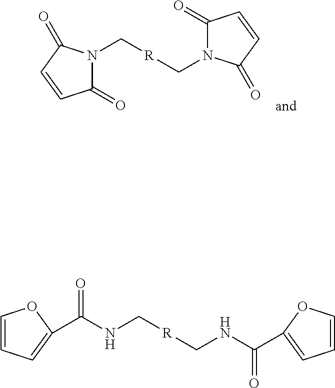

where R is the linking group. For example, R can be an alkyl group (substituted or unsubstituted linear or branched), such as a linear alkyl group having 1 carbon atom, or from about 2 to about 20 carbon atoms, or from about 3 to about 15 carbon atoms, or about 4 carbon atoms, or about 5 carbon atoms, or from about 6 to about 8 carbon atoms, or about 10 carbon atoms, or about 12 carbon atoms; a cyclic alkyl group (substituted or unsubstituted) such as a cyclic alkyl group having about 5 carbon atoms, or about 6 carbon atoms, or about 8 carbon atoms, or about 10 carbon atoms; an aryl group (substituted or unsubstituted) such as a phenyl group or a naphthyl group; an alkylenedioxy group (substituted or unsubstituted) having from 1 carbon atom, or from about 2 to about 20 carbon atoms, or from about 2 to about 10 carbon atoms, or from about 3 to about 8 carbon atoms, such as an ethylenedioxy group; or the like. Each R may be the same or different. For example, R may be selected from the group consisting of a C₆-alkyl group, a cyclohexyl group, a phenyl group, and a diethyleneoxy group.

In still other embodiments, other forms of maleimides and furans can be used, and it will be understood that the present disclosure is not limited to bis- or tris-structures.

The maleimides and furans can be made by reactions known in the art, and modified to incorporate desired linking groups. For example, the bismaleimides can be readily prepared by reacting maleic anhydride with a suitable reactant such as a diamino compound. In a similar manner, the bisfurans can be readily prepared by reacting 2-furoyl chloride with a suitable reactant such as a diamino compound. In one embodiment, where the diamino compound is a diaminoalkane, such as diaminooctane, the bismaleimide and bisfuran can be prepared as follows, wherein R is —CH2)6-:

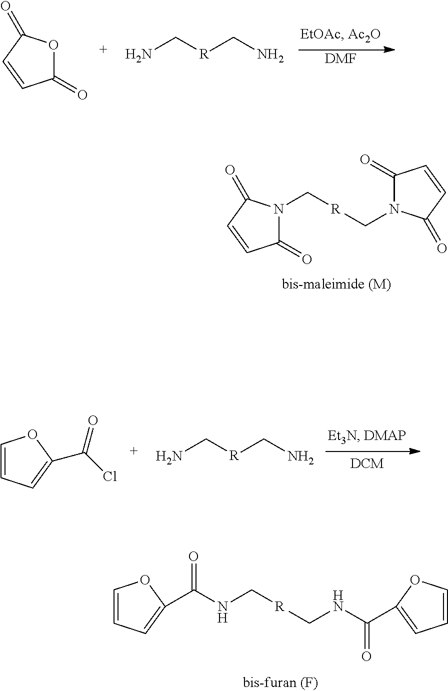

Similar reaction schemes can be used to prepare trigonal maleimides and furans.

In other embodiments, trigonal chemical structures can be used. For example, suitable trigonal maleimides and furans are represented by the following chemical structures:

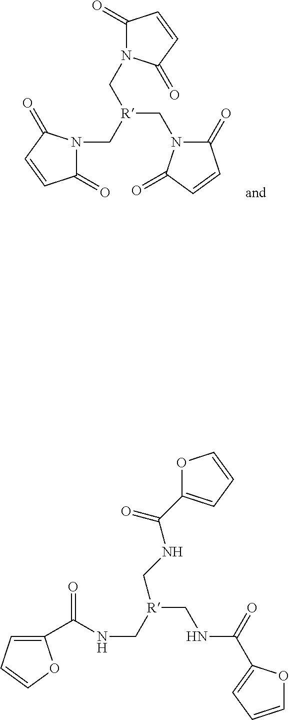

where R′ can be any central atom or molecule, such as, but not limited to, C, N, S, Si, C6H3 (phenyl), or C6H9 (cyclohexyl), and where each arm radiating from the central atom or molecule is the same or different and is the linking group as defined above. Specific embodiments of the trigonal maleimides and furans where R′ is N are represented by the following structures:

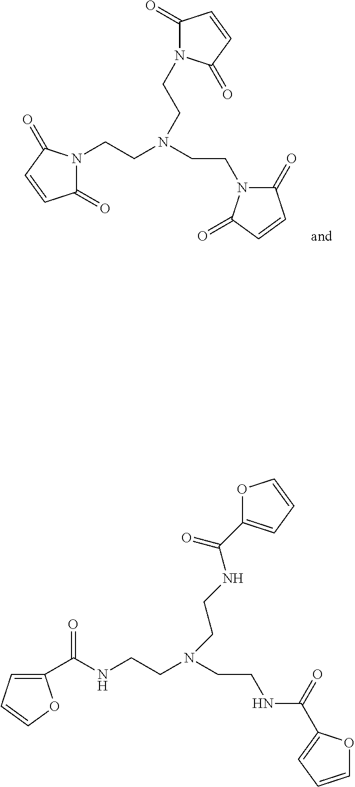 [SMILES: O=C1C=CC(=O)N1CCN(CCN1C(=O)C=CC1=O)CCN1C(=O)C=CC1=O ; O=C(NCCN(CCNC(=O)c1ccco1)CCNC(=O)c1ccco1)c1ccco1]

Synthesis of these compounds can be effected as described above, in this case using a trigonal spacer molecule such as N R3, or CH R3, wherein each R group is the same or different, and can consist of linear or branched alkyl groups, and may contain hetero atoms or aromatic groups or both.

The reversible polymer material in embodiments can include a mixture of maleimide monomer units or species and furan monomer units or species so that the Diels-Alder cyclo-addition reactions can proceed. Heating the solid maleimide/furan mixture above its melting point results in a low viscosity liquid. However, cooling of the mixture promotes Diels-Alder coupling, resulting in the formation of polymers. Heating the polymers above the melting point of the constituent maleimide and furan species reverses the process, re-generating the low viscosity liquid. This reversible transition of the materials from monomer units or species to polymer is exemplified for one set of materials by the following reaction scheme:

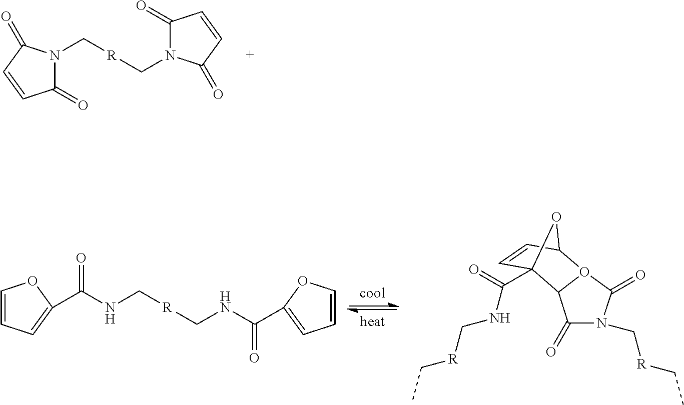

In forming the mixture of maleimide monomer units or species and furan monomer units or species, according to various embodiments, the materials can be in approximately equimolar amounts of functional groups. Thus, for example, where the mixture is formed from bismaleimides having two reactive functional groups and bisfurans having two reactive functional groups, the bismaleimides and bisfurans can be present in a molar ratio of about 1:1, such as from about 1.5:1 to about 1:1.5, or from about 1.3:1 to about 1:1.3, or from about 1.2:1 to about 1:1.2, or from about 1.1:1 to about 1:1.1. Similarly, where the mixture is formed from trigonal maleimides having three reactive functional groups and trigonal furans having three reactive functional groups, the trigonal maleimides and trigonal furans can be present in a molar ratio of about 1:1, such as from about 1.5:1 to about 1:1.5, or from about 1.3:1 to about 1:1.3, or from about 1.2:1 to about 1:1.2, or from about 1.1:1 to about 1:1.1.

However, where the mixture is formed from bismaleimides having two reactive functional groups and trigonal furans having three reactive functional groups, or from trigonal maleimides having three reactive functional groups and bisfurans having two reactive functional groups, the maleimides and furans can be present in a molar ratio of the trigonal material to the bis material of about 2:3, such as from about 2.5:3 to about 2:2.5, or from about 2.3:3 to about 2:2.7, or from about 2.2:3 to about 2:2.8, or from about 2.1:3 to about 2:2.9. Although other ratios of the materials can be used, the reversible polymer material may have too much residual liquid material if the ratio of materials diverges too far from being equimolar. That is, as the ratio becomes unbalanced, there may be too much of one constituent material to react with the other material to form the reversible polymer in the solid state. The excess unreacted material may dilute the coupled reversible polymer and compromise its mechanical integrity.

Also in various embodiments, the materials used to form the mixture can have the same linking group, or the same general type of linking group. Where the mixture is formed from the depicted maleimides and furans shown above, the maleimides and furans have the same linking group R, or at least the same type of linking group R. Thus, for example, the linking group of the maleimides and furans in embodiments is each an alkyl group, such as each a linear alkyl group of the same chain length; or is each a cyclic alkyl group such as each a cyclic alkyl group having the same structure and number of carbon atoms; or is each an aryl group, such as each a phenyl group; or is each an alkylenedioxy group such as each an ethylenedioxy group; or the like.

Mixtures of different spacer groups can be accommodated, provided the chemistries in each of the spacer groups are compatible with one another, such that the two compounds are miscible in each other. For example, mixtures having very dissimilar polarities would be less than optimal, as the two reagents could be unstable and could undergo phase separation. Of course, if desired, different linking groups can be used in the materials.

Similarly, in embodiments, the materials used to form the mixture can be one form of maleimide and one form of furan. This may allow the Diels-Alder reaction to more rapidly progress because the counter functional groups of the materials are more closely positioned to each other in the mixture. However, if desired, more than one type of maleimide and/or more than one type of furan can be used in forming the mixture. Thus, for example, the mixture can be formed from one type of maleimide and one type of furan; or can be formed from one, two, three, or more different maleimides and one, two, three, or more different furans; to provide desirable properties of both the liquid mixture and the solid reversible polymer.

In forming the mixture, the mixture contains at least the reversible polymer material, such as the mixture of the maleimide monomer units or species and furan monomer units or species. Because the ability of the monomers to react together by Diels-Alder cyclo-addition reactions is dependent upon the materials readily contacting each other, it may be desired that as few additional ingredients as possible be included in the mixture. Thus, for example, in one embodiment, the mixture consists entirely of only the maleimide monomer units or species and furan monomer units or species; in other embodiments, the mixture consists essentially of the maleimide monomer units or species and furan monomer units or species, plus additional materials that do not interfere with the ability of the monomers to react to form the reversible polymer material. In still other embodiments, additional components may be included for other intended purposes. Of course, it will be appreciated in each of these variants that the mixture may also include incidental impurities and the like.

Where additional materials are included in the mixture in addition to the maleimides and furans, the maleimides and furans can together be present in the mixture in a majority amount, such as about 50, or about 60, or about 70, or from about 80 to about 90, or about 95, or about 100 percent by weight of the mixture. In other embodiments, the maleimides and furans can together be present in the mixture in a minority amount, such as about 1, or about 5, or about 10, or from about 20 to about 30, or about 40, or about 50 percent by weight of the mixture.

If desired, the composition can include other additives for their conventional purposes. For example, the composition can include one or more of light stabilizers, UV absorbers (which absorb incident UV radiation and convert it to heat energy that is ultimately dissipated), antioxidants, optical brighteners (which can improve the appearance of the image and mask yellowing), thixotropic agents, dewetting agents, slip agents, foaming agents, antifoaming agents, flow agents, waxes, oils, plasticizers, binders, electrical conductive agents, organic and/or inorganic filler particles, leveling agents (i.e., agents that create or reduce different gloss levels), opacifiers, antistatic agents, dispersants, colorants (such as pigments and dyes), biocides, preservatives, and the like. However, additives may adversely affect the speed and degree of the reversible cyclo-addition reactions.

For example, in some embodiments, it may be helpful to include a radical scavenger in the composition. It has been found that, for some reversible polymer mixtures, prolonged heating of the molten liquid can lead to irreversible hardening of the mixture, due to the propensity of maleimide compounds to undergo a 2+2 cyclo-addition reaction when exposed to UV light. As a result of the cyclo-addition reaction, an irreversible polymerization or hardening of the material can occur, which can render the composition unacceptable for some uses such as in a solid inkjet printer. Adding a radical scavenger to those compositions can thus prevent or significantly slow down the cyclo-addition reaction, thereby preventing the irreversible polymerization from occurring, and allowing the molten liquids to maintain their low melt viscosities for a longer period of time.

Where the radical scavenger is to be included, any suitable radical scavenger can be used. Suitable radical scavengers include, for example, sorbitol, methylether hydroquinone, t-butylhydroquinone, hydroquinone, 2,5-di-1-butylhydroquinone, 2,6-di-tert-butyl-4-methyl phenol (or BHT for butylhydroxytoluene), 2,6-di-t-butyl-4-methoxyphenol, nitroxides, 2-tert-butyl-4-hydroxyanisole, 3-tert-butyl-4-hydroxyanisole, propyl ester 3,4,5-trihydroxy-benzoic acid, 2-(1,1-dimethylethyl)-1,4-benzenediol, diphenylpicrylhydrazyl, 4-tert-butylcatechol, N-methylaniline, p-methoxydiphenylamine, diphenylamine, N,N′-diphenyl-p-phenylenediamine, p-hydroxydiphenylamine, phenol, octadecyl-3-(3,5-di-tert-butyl-4-hydroxyphenyl)propionate, tetrakis(methylene(3,5-di-tert-butyl)-4-hydroxy-hydrocinnamate)methane, phenothiazines, alkylamidonoisoureas, thiodiethylene bis(3,5,-di-tert-butyl-4-hydroxy-hydrocinnamate, 1,2,-bis(3,5-di-tert-butyl-4-hydroxyhydrocinnamoyl)hydrazine, tris(2-methyl-4-hydroxy-5-tert-butylphenyl)butane, cyclic neopentanetetrayl bis(octadecyl phosphite), 4,4′-thiobis(6-tert-butyl-m-cresol), 2,2′-methylenebis(6-tert-butyl-p-cresol), oxalyl bis(benzylidenehydrazide), and naturally occurring antioxidants such as raw seed oils, wheat germ oil, tocopherols, and gums, and mixtures thereof. Suitable nitroxides include, for example, 2,2,6,6-tetramethyl-1-piperidinyloxy (TEMPO), 2,2,6,6-tetraethyl-1-piperidinyloxy, 2,2,6-trimethyl-6-ethyl-1-piperidinyloxy, 2,2,5,5-tetramethyl-1-pyrrolidinyloxy (PROXYL), dialkyl nitroxide radicals such as di-t-butyl nitroxide, diphenyl nitroxide, t-butyl-t-amyl nitroxide, 4,4-dimethyl-1-oxazolidinyloxy (DOXYL), 2,5-dimethyl-3,4-di carboxylic-pyrrole, 2,5-dimethyl-3,4-diethylester-pyrrole, 2,3,4,5-tetraphenyl-pyrrole, 3-cyano-pyrroline-3-carbamoyl-pyrroline, 3-carboxylic-pyrroline, 1,1,3,3-tetramethylisoindolin-2-yloxyl, 1,1,3,3-tetraethylisoindolin-2-yloxyl, porphyrexide nitroxyl radicals such as 5-cyclohexyl porphyrexide nitroxyl and 2,2,4,5,5-pentamethyl-D3-imidazoline-3-oxide-1-oxyl and the like, galvinoxyl and the like, 1,3,3A trimethyl-2-azabicyclo[2,2,2]octane-5-oxide-2-oxide, 1A azabicyclo[3,3,1]nonane-2-oxide, and the like. Substituted variants of these radical scavengers can also be used, such as 4-hydroxy-TEMPO, 4-carboxy-TEMPO, 4-benzoxyloxy-TEMPO, 4-methoxy-TEMPO, 4-carboxylic-4-amino-TEMPO, 4-chloro-TEMPO, 4-hydroxylimine-TEMPO, 4-oxo-TEMPO, 4-oxo-TEMPO-ethylene ketal, 4-amino-TEMPO, 3-carboxyl-PROXYL, 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3-maleimido-PROXYL, 3,4-di-t-butyl-PROXYL, 3′-carboxylic-PROXYL, 2-di-t-butyl-DOXYL, 5-decane-DOXYL, 2-cyclohexane-DOXYL, and the like.

Optionally, many commercial antioxidant stabilizers function by trapping free radicals and thus may be used as a radical scavenger. For example, IRGASTAB® UV 10 is a nitroxide and may suitably be used. Other suitable compounds may include, for example, NAUGARD® 524, NAUGARD® 635, NAUGARD® A. NAUGARD® 1-403, and NAUGARD® 959, commercially available from Crompton Corporation, Middlebury, Conn.; NAUGARD® 76. NAUGARD® 445, and NAUGARD® 512 commercially available by Uniroyal Chemical Company; IRGANOX® 1010 and IRGASTAB® UV 10, commercially available from Ciba Specialty Chemicals; GENORAD™ 16 and GENORAD™ 40 commercially available from Rahn A G, Zurich, Switzerland; and the like, as well as mixtures thereof.

The radical scavenger may be present in the composition in any effective amount. For example, it may be present in an amount of from about 0.01% to about 10% by weight of the composition, or from about 0.1% to about 8% by weight of the composition, or from about 1% to about 6% by weight of the composition, or from about 2% to about 5% by weight of the composition.

In the molten state, where the composition is heated to above the melting point of the reversible polymer material, the composition is a low viscosity liquid. For example, the liquid composition can have a viscosity of from about 1 cPs to about 100 cPs, such as from about 1 cPs to about 50 cPs, or about 2 cPs, or from about 5 cPs to about 10 cPs, or about 15 cPs at a temperature above the melting point of the reversible polymer material. In another embodiment, the liquid composition can have a viscosity of from about 1 cPs to about 100 cPs, such as from about 1 cPs to about 50 cPs, or about 1 cPs, or from about 2 cPs to about 30 cPs, or about 40 cPs, or from about 2 cPs to about 20 cPs, at a temperature of from about 75° C. to about 200° C., such as about 150° C., or from about 90° C. to about 180° C., or about 125° C., or from about 100° C. to about 150° C.

According to embodiments, the ink composition may have a viscosity in the range of from about 1 cPs to about 100 cPs at a temperature range of from about 75° C. to about 200° C., or from about 2 cPs to about 20 cPs at a temperature range of from about 90° C. to about 180° C., or from about 10 cPs to about 20 cPs at a temperature range of from about 100° C. to about 150° C., although the viscosities and temperatures will vary depending on the spacer chemistry that is used. As the composition is cooled, cyclo-addition takes place, resulting in a hard polymer with excellent film forming and adhesion characteristics.

### Composition Application Methods

Successive layers of the reversible polymer ink composition herein may be deposited to form an object having a selected height and shape. The successive layers of the ink may be deposited to a platform, or a substrate, or to a previous layer of solidified material in order to build up a three-dimensional object (i.e., intended product and/or sacrificial product) in a layer by layer fashion. Of course, other application methods can also be used, such as spraying, coating, dipping, and the like, depending upon the desired use and end-product.

When the composition is applied onto a substrate using digital ink jet printing, it can be applied at any desired thickness and amount. The composition can be applied in at least one pass over the substrate, or it can be applied as multiple, partially overlapping passes over the substrate.

In an embodiment, a method of printing a three-dimensional object from an ink composition containing reversible polymers generally comprises forming the ink composition, depositing by ink jetting a predetermined amount of the ink composition in liquid state over a substrate surface, for example, as a layer and subsequently cooling the layer, thereby solidifying it. As the layer cools, the reversible polymer material transitions from the liquid state to a solid state by reversible cyclo-addition reactions within a time period of less than about 10 seconds, or from about 1 to about 10 seconds, or less than about 30 seconds, or between about 30 to about 60 seconds, or up to about 60 seconds, thereby solidifying the layer.

In layer by layer 3-D printing, depending on the size of the 3-D printed object, a layer may be printed within the solidification time of the previously printed layer so as not to encounter a fully hardened layer; therefore, solidification times can be extended or shortened by varying the properties of the reversible polymer as explained above. Accordingly, solidification times of more than about 60 minutes or less than about 1 second may be used.

Next, another ink layer containing the same or different predetermined amount of ink is deposited over the prior layer and cooled to harden the liquid ink. The 3-D printing process continues by repeating these steps by successively depositing and cooling additional amounts, layers or films of the ink composition until the intended three-dimensional object is formed.

Accordingly, the layer thicknesses may be the same or different and can be in the range of from about 10μ to about 1000μ, or from about 20μ to about 500μ, or from about 50μ to about 200μ.

According to another embodiment of forming a 3-D object, a sacrificial product, structure or component is made of an ink composition including reversible polymers. The ink composition is deposited by ink jetting a predetermined amount in liquid state over a substrate surface as an ink layer, and subsequently cooling the ink layer to form the sacrificial layer. As the sacrificial layer cools, the reversible polymer material can transition from the liquid state to a solid state by reversible cyclo-addition reactions within time periods mentioned above.

Next, another ink layer containing the same or different predetermined amount of ink is deposited over the initial sacrificial layer, and cooled to form another sacrificial layer. The process continues by repeating these steps by successively depositing and cooling additional amounts of the ink composition until the sacrificial product is formed.

In embodiments, an intended 3-D product adjacent the 3-D sacrificial product is formed so that at least one structural feature of the intended 3-D product is physically supported by the sacrificial 3-D product. The intended 3-D product may or may not be formed according to embodiments herein.

As described above, the temperature dependent viscosities of the molten reversible polymer liquids, time required for liquid-solid phase transitions, as well as the rheology and adhesion properties of the solid reversible polymer films, can advantageously be controlled by varying the spacer group chemistry. In this respect, these variable properties can be adjusted to prepare an optimal low melting point reversible polymer that can be used as a sacrificial material in 3-D printing. The low melt viscosities can enable jetting of a well-defined ink stream to form a 3-D sacrificial shape, as well as easy removal of the solid material after the printing is completed or when the sacrificial material is no longer needed. Because of its sufficiently low viscosity when melted, reverse polymer sacrificial structures can be removed from the intended 3-D structure after printing has been completed.

Exemplary substrates include, but are not limited to, plain paper, coated paper, plastics, polymeric films, treated cellulosics, wood, xerographic substrates, metal substrates, ceramic and mixtures thereof, optionally comprising additives coated thereon.

The reversible polymer compositions may be employed with any desired printing systems including systems suitable for preparing 3-D objects, such as a solid object printer, piezoelectric ink jet printer, acoustic ink jet printer, and the like. In other embodiments, the ink materials may be used for manual preparation of 3-D objects, such as through the use of molds or by manual deposition of the ink material, to prepare a desired 3-D object. The rheological properties of the material of the present disclosure may be tuned to achieve robust jetting at elevated temperatures and a degree of mechanical stability at ambient substrate temperatures (i.e., room temperature).

An exemplary ink jet printing device as described in commonly assigned, U.S. Pat. No. 8,061,791, incorporated by reference herein in its entirety, may be employed to 3-D print reversible polymers herein. The ink jet printing apparatus includes at least an ink jet print head and a print region surface toward which ink is jetted from the ink jet print head, wherein a height distance between the ink jet print head and the print region surface is adjustable. The ink jet print head or print region surface may be movable in three dimensions—x, y, and z—enabling the build-up of an object of any desired size and geometry. A computer and/or controller may control the ink jet print head to deposit the appropriate amount and/or layers of ink at locations so as to form the object with the desired shape, dimensions and geometries.

### EXAMPLES

The following Examples are intended to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### General Procedure for Synthesis of Maleimides

In a 500 mL RBF (round-bottomed flask) equipped with a magnetic stir bar was dissolved maleic anhydride (10.5 eq) in 75 mL DMF (dimethylformamide). The resulting solution was chilled on ice and the 1,8-octanediamine (5 eq) dissolved in DMF (75 mL) was added dropwise over ˜20 min. The ice bath was removed, and sodium acetate (1 eq) and acetic anhydride (11 eq) were added in one portion, and the mixture stirred overnight at 50° C. The mixture turned dark brown within 30 minutes of the addition of NaOAc and Ac₂O. DMF was removed by vacuum distillation (60° C.), and DCM (dichloromethane) (150 mL) was added to the dark brown mixture. The organic layer was extracted with NaHCO₃ (5×100 mL), dried over MgSO₄, and the solvent removed under vacuum. The resulting compounds were purified by column chromatography.

1,1′-(octane-1,8-diyl)bis(1H-pyrrole-2,5-dione) (denoted M1): The general procedure was carried out using maleic anhydride (14.27 g, 146 mmol), 1,8-octanediamine (10.0 g, 69.3 mmol), sodium acetate (1.14 g, 13.9 mmol) and acetic anhydride (15.57 g, 153 mmol). The resulting compound was purified by column chromatography (98:2 DCM:EtOAc), and the product obtained as a white solid (5.2 g/25%).

1,1′-(cyclohexane-1,3-diylbis(methylene))bis(1H-pyrrole-2,5-dione) (denoted M2): The general procedure was carried out using maleic anhydride (20.59 g, 210 mmol), 1,3-cyclohexanebis(methylamine) (14.22 g, 100 mmol), sodium acetate (1.64 g, 20 mmol), and acetic anhydride (22.46 g, 220 mmol). The resulting compound was purified by column chromatography (98:2 DCM:EtOAc), and the product obtained as a white solid (3.55 g/12%).

1,1′-(1,3-phenylenebis(methylene))bis(1H-pyrrole-2,5-dione) (denoted M3): The general procedure was carried out using maleic anhydride (20.59 g, 210 mmol), m-xylylenediamine (13.62 g, 100 mmol), sodium acetate (1.64 g, 20 mmol), and acetic anhydride (22.46 g, 220 mmol). The resulting compound was purified by column chromatography (97:3 DCM:EtOAc), and the product obtained as a white solid (6.51 g/22%).

1,1′-((ethane-1,2-diylbis(oxy))bis(ethane-2,1-diyl))bis(1H-pyrrole-2,5-dione) (denoted M4): The general procedure was carried out using maleic anhydride (13.23 g, 135 mmol), 2,2′-(ethylenedioxy)bis(ethylamine) (10.0 g, 67.5 mmol), sodium acetate (1.11 g, 13.5 mmol), and acetic anhydride (15.15 g, 148 mmol). The resulting compound was purified by column chromatography (95:5 DCM:EtOAc), and the product obtained as a white solid (4.5 g/22%).

1,1′,1″-(nitrilotris(ethane-2,1-diyl))tris(1H-pyrrole-2,5-dione) (denoted M5): In a 500 mL round-bottomed flask under argon was dissolved maleic anhydride (20.1 g, 205 eq) in 75 mL DMF. The resulting solution was chilled on ice and then tris(2-aminoethyl)amine (10.0 g, 68.4 mmol) dissolved in DMF (75 mL) was added dropwise over ˜20 min. The ice bath was removed, and sodium acetate (1.68 g, 20.52 mmol) and acetic anhydride (23.04 g, 226 mmol) were added in one portion, and the mixture stirred overnight at 50° C. The mixture turned dark brown within 30 minutes of the addition of NaOAc and Ac₂O. DMF was removed by vacuum distillation (60° C.), and DCM (150 mL) was added to the dark brown mixture. The organic layer was extracted with NaHCO₃ (5×100 mL), dried over MgSO₄, and the solvent removed under vacuum. The resulting compound was purified by column chromatography (95:5 DCM:EtOAc) to yield a light yellow solid (8.0 g, 30%).

### General Procedure for Synthesis of Furans

To a 500 mL RBF equipped with a magnetic stir bar was added the 1,8-octanediamine (47.9 eq), triethylamine (95.7 eq), DMAP (4-Dimethylaminopyridine) (1 eq) and DCM (200 mL). The solution was chilled on ice, then furoyl chloride (100 eq) in DCM (50 mL) was added dropwise. The ice bath was removed, and the mixture stirred at room temperature overnight. The organic layer was extracted with NaHCO₃ (5×100 mL), dried over MgSO₄, and the solvent removed under vacuum. The resulting compounds were purified by column chromatography.

N,N′-(octane-1,8-diyl)bis(furan-2-carboxamide) (denoted F1): The general procedure was carried out using 1,8-octanediamine (10.0 g, 69.3 mmol), triethylamine (14.2 g, 141 mmol), DMAP (0.17 g, 1.35 mmol) and furoyl chloride (19.0 g, 146 mmol). The resulting compound was purified by column chromatography (98:2 DCM:EtOAc), and the product obtained as a white solid (21.5 g/92%).

N,N′-(cyclohexane-1,3-diylbis(methylene))bis(furan-2-carboxamide) (denoted F2): The general procedure was carried out using 1,3-cyclohexanebis(methylamine) (10.0 g, 70.3 mmol), triethylamine (14.2 g, 141 mmol), dimethylaminopyridine (0.17 g, 1.41 mmol), and furoyl chloride (19.0 g, 146 mmol). The resulting compound was purified by column chromatography (95:5 DCM:EtOAc), and the product obtained as a white solid (3.5 g/15%).

N,N′-(1,3-phenylenebis(methylene))bis(furan-2-carboxamide) (denoted F3): The general procedure was carried out using m-xylylenediamine (10.0 g, 73.4 mmol), triethylamine (14.9 g, 147 mmol), dimethylaminopyridine (0.17 g, 1.41 mmol), and furoyl chloride (20.13 g, 154 mmol). The resulting compound was purified by column chromatography (95:5 DCM:EtOAc), and the product obtained as a white solid (21.8 g/92%).

N,N′-((ethane-1,2-diylbis(oxy))bis(ethane-2,1-diyl))bis(furan-2-carboxamide) (denoted F4): The general procedure was carried out using 2,2′-(ethylenedioxy)bis(ethylamine) (10.0 g, 67.5 mmol), triethylamine (13.66 g, 135 mmol), dimethylaminopyridine (0.17 g, 1.41 mmol), and furoyl chloride (18.5 g, 142 mmol). The resulting compound was purified by column chromatography (95:5 DCM:EtOAc), and the product obtained as a white solid (10.9 g/48%).

N,N′,N″-(nitrilotris(ethane-2,1-diyl))tris(furan-2-carboxamide) (denoted F5): In a 500 mL RBF under argon was added the 1,8-octanediamine (10.0 g, 68.4 mmol), triethylamine (20.76 g, 205 mmol), DMAP (0.68 g, 20.5 mmol) and DCM (350 mL). The solution was chilled on ice, then furoyl chloride (27.7 g, 212 mmol) in DCM (150 mL) was added dropwise. The ice bath was removed, and the mixture stirred at room temperature overnight. The organic layer was extracted with NaHCO₃ (5×100 mL), dried over MgSO₄, and the solvent removed under vacuum. The resulting compound was purified by column chromatography (99:1 DCM:EtOAc) to yield a white solid (16.1 g, 82%).

The bismaleimides M1 to M4 and bisfuran F1 to F4 prepared above are represented by the following structures, where the linking group R is varied as shown:

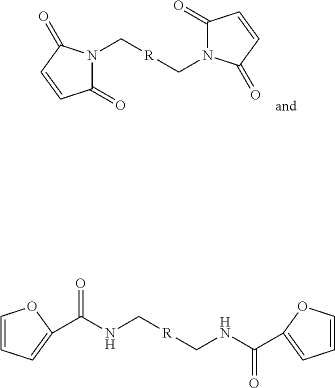

| Compound | R |
|---|---|
| M1, F1 | 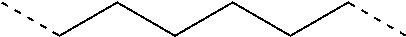 |
| M2, F2 | 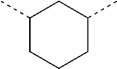 |
| M3, F3 | 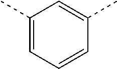 |
| M4, F4 | 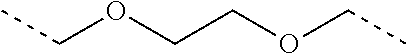 |

The trigonal maleimide M5 and trigonal furan F5 are represented by the following structures:

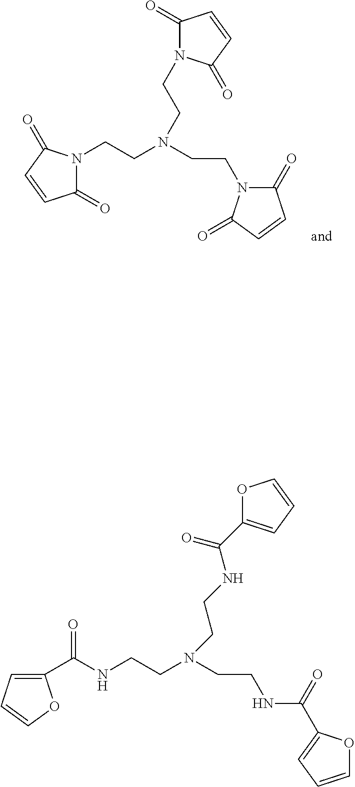 [SMILES: O=C1C=CC(=O)N1CCN(CCN1C(=O)C=CC1=O)CCN1C(=O)C=CC1=O ; O=C(NCCN(CCNC(=O)c1ccco1)CCNC(=O)c1ccco1)c1ccco1]

### Examples 1-4

Mixtures of the pairs of bismaleimides and bisfurans (M1 and F1, M2 and F2, M3 and F3, M4 and F4), varying only in their linking chemistry, were prepared by mixing the maleimide and the respective furan on about a 1:1 molar basis, and characterized. The samples were used for the following testing and analysis.

### Analysis

Heating the solid maleimide/furan mixtures above their melting points resulted in very low viscosity liquids, while cooling of the mixtures resulted in Diels-Alder coupling, resulting in the formation of solid polymers. Subsequent re-heating of the polymers above the melting point of the constituent maleimide/furan reversed the process, re-generating the low viscosity liquid. The reversibility of the process was verified by ¹H NMR spectroscopy and differential scanning calorimetry (DSC).

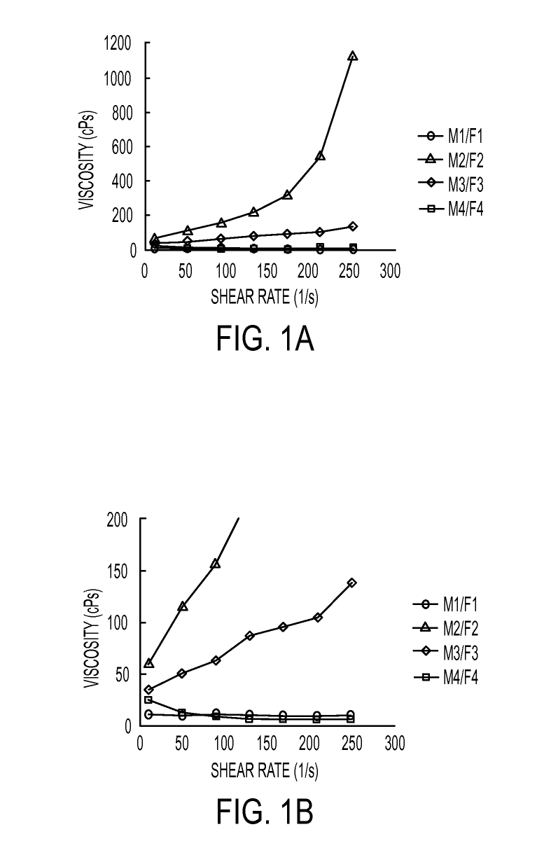

The mixtures were heated above their melting points to measure their molten viscosity characteristics. The mixture of Example 1 (mixture of M1 and F1) was heated to 120° C.; the mixture of Example 2 (mixture of M2 and F2) was heated to 190° C.; the mixture of Example 3 (mixture of M3 and F3) was heated to 150° C.; and the mixture of Example 4 (mixture of M4 and F4) was heated to 90° C. Viscosities were measured using an AR 2000 viscometer, available from TA Instruments. Measurements were made using a 25 mm plate assembly, set at a gap width of 200 μm. Shear rate was varied from 10 s⁻¹ to 250 s-¹ during the course of the measurement. Viscosities of molten M/F mixtures are shown in FIGS. 1A and 1B, where FIG. 1A shows M1/F1 viscosity measured at 120° C., M2/F2 viscosity measured at 190° C., M3/F3 viscosity measured at 150° C. and M4/F4 viscosity measured at 90° C., and where FIG. 1B is a magnified scale of a portion of FIG. 1A. The dilatant behavior of the mixtures M3/F3 and M4/F4 of Examples 3 and 4 respectively is believed to be due to the higher temperatures required for melting and viscosity measurement of these particular mixtures, which resulted in an irreversible cross-linking reaction that occurred over the course of the measurement.

Polymer films were cast using samples of the neat, molten monomers mixtures, and the polymer films were allowed to cool. Hardness and modulus were measured directly on these films with a Hysitron Triboscan® nanointender using a Berkovich diamond tip. Samples were prepared by transferring the powder mixture (˜50 mg) to a steel sample disc (15 mm diameter). The disc was placed on a hotplate that was pre-heated approximately 20° C. above the melting point of the mixture. Air bubbles that appeared during melting were removed by agitation of the liquid with a clean spatula. The sample discs were removed from the heat source and stored at 60° C. for at least 24 hours, resulting in smooth films with relatively flat surfaces. Samples were allowed to equilibrate at room temperature for 1 h before measurements were made. A 10-2-10 load function was used (10 second load time, 2 second hold, and 10 second unload time) with a maximum load of 1000 μN. Measurements were made in 3×3 grids, with a spacing of 15 μm between each indentation. Three separate locations spaced at least 1 mm apart were used on each sample stub. Hardness and modulus values were determined by the Triboscan® software, and reported as an average of these 27 measurements. Control samples (PMMA, quartz) were measured before and after each set of measurements to ensure that measurements were within 5% of their expected values.

Rheological data of polymer films measured by nanoindentation is shown in FIGS. 2A and 2B, where FIG. 2A shows the reduced modulus (Eᵣ) and FIG. 2B shows the hardness of the polymer films made from the mixtures. For comparison purposes, FIGS. 2A and 2B also include measurements for polymer films formed from a Solid Ink, as used in commercially available Xerox ColorQube® printers, and a toner resin, used in conventional Xerox copiers and printers.

The quality of the films was also assessed for clarity, hardness and brittleness by visual inspection of the films. The assessment was made to assess the effect of spacer group on the final polymer films. The results of the assessment are provided in the following table.

| Film Composition | Visual Inspection |
|---|---|
| Example 1 | The linear alkyl chain resulted in very brittle, opaque |
| | films, believed to be due to the crystallinity of the |
| | spacer group. The film exhibited crystallinity as |
| | measured by X-Ray Diffraction Spectroscopy (XRD). |
| Example 2 | The cyclohexyl spacer gave a clear film, but the film |
| | was still very brittle with apparent cracks. The film |
| | was amorphous. |
| Example 3 | The phenyl spacer gave a clear film, but the film was |
| | still very brittle with apparent cracks. The film |
| | was amorphous. |
| Example 4 | The diethyleneoxy spacer gave a very durable, clear |
| | polymer film that was considerably less brittle than |
| | the other three materials. The film was amorphous. |

The above testing demonstrates that the phenyl spacer group in Example 3 provided the hardest material of those tested, although the polymer film was quite brittle. Example 4, having a diethyleneoxy spacer, formed a polymer film that was slightly softer, but was much less brittle, as compared to Example 3. Nonetheless, all of the films formed from the materials of Examples 1-4 were considerably harder than the conventional toner resin, and dramatically harder than the conventional solid ink.

Solidification time was also found to be dependent upon the spacer chemistry of the materials. Attempts to measure the solidification time were made using Time Resolved Optical Microscopy (TROM); however, these attempts were unsuccessful because only the film of Example 1 displayed any degree of crystallinity while the remaining three films were all amorphous and thus were not visible by the optical methods used in the TROM technique. Instead, simple tapping of the films with a spatula was used, where an audible click was denoted as complete solidification of the polymer. In this testing, the films of both Example 1 and Example 4 took several hours to completely harden, while films of Example 2 and Example 3 solidified in seconds. A combination of the materials was also tested for solidification time, and it was found that an 80:20 mixture of Example 4 and Example 3 resulted in a clear, non-cracking film that hardened within minutes.

It will be appreciated that variations of the above-disclosed and other features and functions, or alternatives thereof, can be combined into many other different systems or applications. Also, various presently unforeseen or unanticipated alternatives, modifications, variations or improvements therein can be subsequently made by those skilled in the art, and are also intended to be encompassed by the following claims.

What is claimed is:

1. An ink composition for three-dimensional printing of objects, comprising:
a reversible polymer material; and
wherein the composition in a liquid state has a viscosity of from about 1 cPs to about 100 cPs at a temperature of from about 75° C. to about 200° C.

2. The composition of claim 1, wherein the reversible polymer material transitions from a liquid state to a solid state within a time period of between about 1 seconds to about 60 seconds.

3. The composition of claim 1, wherein the reversible polymer material comprises a diene compound and a dienophile compound.

4. The composition of claim 1, wherein the reversible polymer material has a reduced modulus (Eᵣ) value of from about 6.0 GPa to about 8.0 GPa in a solid state.

5. The composition of claim 1, wherein the reversible polymer material has a hardness value of from about 0.25 GPa to about 0.60 GPa in a solid state.

6. The composition of claim 1, wherein the reversible polymer material has a brittleness value of from about 1 g to about 30 g, wherein the brittleness value is defined as the weight of a metal ball, that a film of the reversible polymer material can withstand, when dropped on the film from a height of 25 cm.

7. The composition of claim 1, wherein the composition has a visible light transmission rate of 0-100% in a solid state.

8. The composition of claim 3, wherein the reversible polymer material comprises a maleimide compound and a furan compound.

9. A method of forming a three-dimensional object, comprising:
depositing an ink composition in layers over a surface;
cooling one of the layers of ink composition;
wherein the ink composition includes a reversible polymer material; and
wherein the reversible polymer material transitions from a liquid state to a solid state within a time period of up to about 60 seconds.

10. The method of claim 9, wherein the step of depositing comprises ink jetting.

11. The method of claim 9, wherein the three-dimensional object comprises an intended product or a sacrificial product.

12. The method of claim 9, further comprising transitioning the reversible polymer material from the solid state to the liquid state.

13. The method of claim 9, further comprising heating the one of the layers of ink composition.

14. The method of claim 9, wherein the one layer has a thickness of from about 10μ to about 1000μ.

15. A method of forming a three-dimensional object, comprising:
ink jetting an ink composition in layers over a surface;
solidifying one of the layers of ink composition;
wherein the ink composition includes a reversible polymer material; and
wherein the ink composition, when solidified, has a hardness value of from about 0.25 GPa to about 0.60 GPa.

16. The method of claim 15, further comprising forming an intended product.

17. The method of claim 15, further comprising forming a sacrificial product.

18. The method of claim 15, wherein the three-dimensional object is an intended product, and the method further comprises supporting the intended product with a sacrificial product.

19. The method of claim 15, wherein the three-dimensional object is a sacrificial product, and the method further comprises destroying the sacrificial product.

20. The method of claim 15, further comprising liquefying the one of the layers of ink composition.
